(19) United States
(12) Patent Application Publication
(10) Pub. No.: US 2006/0072716 A1
(43) Pub. Date: Apr. 6, 2006

(54) Downloadable and controllable music-on-hold

(75) Inventor: Kim-Oanh Thi Pham, Milpitas, CA (US)

Correspondence Address: DEMONT & BREYER, LLC, SUITE 250, 100 COMMONS WAY, HOLMDEL, NJ, 07733, US

(73) Assignee: Avaya Technology Corp., Basking Ridge, NJ (US)

(21) Appl. No.: 10/950,892

(22) Filed: Sep. 27, 2004

(51) Int. Cl. H04M 1/64

(52) U.S. Cl. 379/88.17

(57) ABSTRACT

A method is disclosed that enables a telecommunications terminal user who is on hold during a call to determine which audio segments, such as musical compositions, are to be played, without some of the costs, disadvantages, and limitations of techniques in the prior art. The illustrative embodiment of the present invention provides a controllable music-on-hold capability that allows the user to enter commands via the user's telecommunications terminal keypad. In accordance with the illustrative embodiment of the present invention, a structure for storing computer files, referred to as an “audio segment box,” is established in a data-processing system. The audio segment box is similar to a “voice mail box” used in voice mail systems, except that the audio segment box is designated for audio segments that include musical compositions.

### FIELD OF THE INVENTION

The present invention relates to telecommunications in general, and, more particularly, to a technique for providing music and other audio signals to a telecommunications terminal user who is on hold during a call.

### BACKGROUND OF THE INVENTION

FIG. 1 depicts telecommunications system 100 in the prior art. Telecommunications system 100 comprises telecommunications terminals 101-1 through 101-J, wherein J is a positive integer; switch 102; and music source 103, interconnected as shown.

Telecommunications terminals 101-j, for j=1 through J, communicate with each other via switch 102 in well-known fashion. By using telecommunications terminal 101-j, a user (e.g., a calling party, a called party, etc.) is able to make calls, receive calls, leave voice mail messages, retrieve voice mail messages, and put other users on hold.

Switch 102 enables two or more telecommunications terminals 101-j to communicate with each other by electrically connecting a telecommunications terminal to another telecommunications terminal and by passing signals between the telecommunications terminals in well-known fashion. Switch 102 receives audio signals (e.g., voice, music, etc.) or data signals, or both, from telecommunications terminal 101-j. Switch 102 transmits audio signals (e.g., voice, music, etc.) or data signals, or both, to telecommunications terminal 101-j. Switch 102 also transmits to telecommunications terminal 101-j audio signals from music source 103 when the terminal is put on hold.

Music source 103 provides audio signals, such as music and announcements, to one or more telecommunications terminals 101-j that are put on hold during calls with other telecommunications terminals. The “music-on-hold” capability that music source 103 provides is a popular feature in a telecommunications system such as a private branch exchange (or “PBX”). System administrators use the music-on-hold feature to entertain telecommunications terminal users during the time on hold.

Music source 103 typically acquires the music that it provides to the telecommunications users from one of two sources: from a radio station or from a memory. Although providing music from either source has the advantage of being straightforward, there are some disadvantages. The disadvantage with using music from a radio station is that the radio station determines the music and not the PBX administrator. The disadvantage with using music stored in a memory is that the music repeats over time and in a pre-programmed order.

What is needed is an improvement in how music, as well as other audio information, is provided to telecommunications terminal users who are put on hold, without some of the costs, disadvantages, and limitations of the prior art.

### SUMMARY OF THE INVENTION

The present invention enables a telecommunications terminal user who is on hold during a call to determine which audio segments, such as musical compositions, are to be played, without some of the costs, disadvantages, and limitations of techniques in the prior art. The illustrative embodiment of the present invention provides a controllable music-on-hold capability that allows the user to enter commands via the user's telecommunications terminal keypad.

In accordance with the illustrative embodiment of the present invention, a structure for storing computer files, referred to as an “audio segment box,” is established in a data-processing system. The audio segment box is similar to a “voice mail box” used in voice mail systems, except that the audio segment box is designated for audio segments that include musical compositions. Music files that represent musical compositions are downloaded by a system administrator into the audio segment box in a storage medium. The music files are formatted so that they can be processed in a manner similar to how a voice messaging system processes voice mail messages. The storage medium, such as a Multimedia Memory Card, is removable so that the audio segments can be downloaded more easily, which allows more convenient updating of the programming content.

The data-processing system also has a music playback menu that the telecommunications terminal user who is on hold will hear. For example, the user might hear “At any time when the music is playing, press ‘4’ to skip backward to the previous song or press ‘6’ to skip forward to the next song.” In accordance with the illustrative embodiment of the present invention, a system administrator can configure the data-processing system to provide the playback menu and playback control to the user only when the estimated hold time exceeds a specified value (e.g., one minute, etc.). Alternatively, the data-processing system can provide the playback menu and playback control to the user regardless of the estimated hold time.

The controllable music-on-hold technique provided in the illustrative embodiment offers users the ability to control what they are listening to while on hold so that the users are not forced to listen to the same music programming when on hold and can skip past songs that they dislike. The control of music playback can be implemented in a manner that is similar to how a user controls playback of voice mail messages. In fact, the technique can be optionally implemented as part of an integrated messaging system, in which the audio segments are stored in an audio segment box and the voice mail messages are stored in a voice mail box. Advantageously, the similar storage structures for both the audio segments and voice messages can enable an integrated messaging system that features easy administration and a harmonized control interface.

The illustrative embodiment of the present invention comprises: receiving at a data-processing system a first signal that conveys a command from a telecommunications terminal; and transmitting from the data-processing system to the telecommunications terminal an audio segment based on the command; wherein the telecommunications terminal is on hold during a call.

### BRIEF DESCRIPTION OF THE DRAWINGS

FIG. 1 depicts telecommunications system 100 in the prior art.

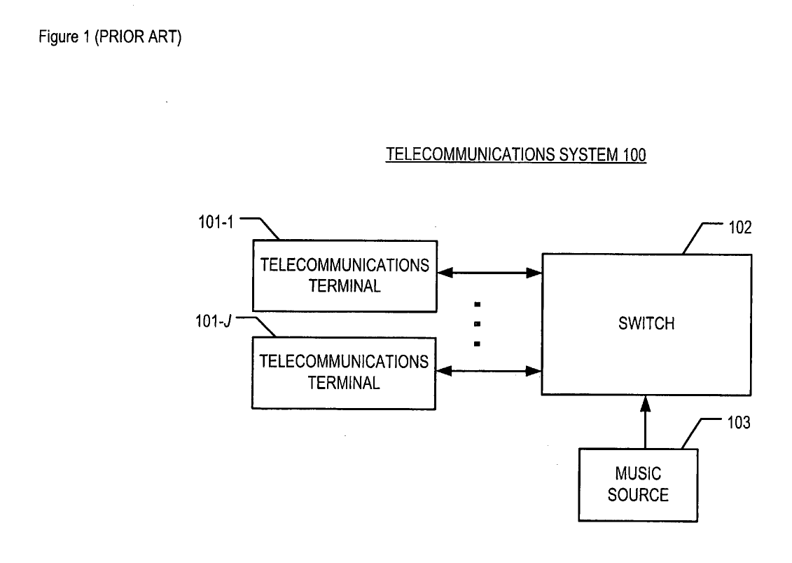

FIG. 2 depicts telecommunications system 200 in accordance with the illustrative embodiment of the present invention.

FIG. 3 depicts a block diagram of data-processing system 203, as shown in FIG. 2, in accordance with the illustrative embodiment of the present invention.

FIG. 4 depicts a block diagram of how information is stored and organized in memory 303, in accordance with the illustrative embodiment of the present invention.

FIG. 5 depicts a first flowchart of the salient tasks of data-processing system 203, in accordance with the illustrative embodiment of the present invention.

FIG. 6 depicts a second flowchart of the salient tasks of data-processing system 203, in accordance with the illustrative embodiment of the present invention.

### DETAILED DESCRIPTION

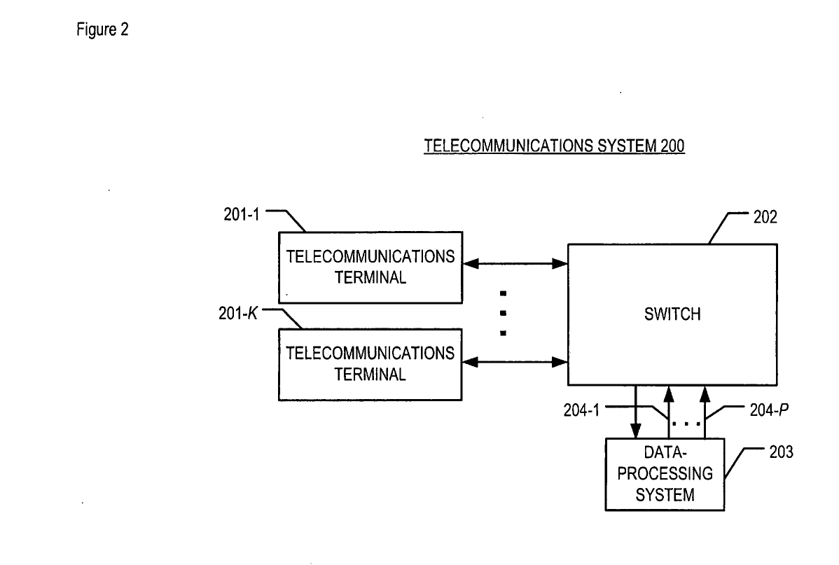

FIG. 2 depicts telecommunications system 200 in accordance with the illustrative embodiment of the present invention. Telecommunications system 200 comprises telecommunications terminals 201-1 through 201-K, wherein K is a positive integer; switch 202; data-processing system 203; and communications channels 204-1 through 204-P, wherein P is a positive integer, interconnected as shown.

Telecommunications terminals 201-k (also referred to as “terminal 201-k ”), for k=1 through K, communicate with each other via switch 202 in well-known fashion. By using terminal 201-k, a user (e.g., a calling party, a called party, etc.) is able to make calls, receive calls, leave voice mail messages, retrieve voice mail messages, and put other users on hold. Also by using terminal 201-k, a user is able to control audio (e.g., music, etc.) playback while on hold during a call with another user, in accordance with the illustrative embodiment of the present invention. It will be clear to those skilled in the art how to make and use terminal 201-k.

Switch 202 enables terminals 201-k, for k=1 through K, to communicate with each other by electrically connecting a terminal to another terminal and by passing signals between the terminals in well-known fashion. Switch 202 is a private branch exchange (or “PBX”), in accordance with the illustrative embodiment of the present invention. In some alternative embodiments, switch 202 might be a different type of switch. Switch 202 receives audio signals (e.g., voice, music, etc.) or data signals, or both, from terminal 201-k. Switch 202 transmits audio signals (e.g., voice, music, etc.) or data signals, or both, to terminal 201-k.

Switch 202 also receives control signals that convey one or more commands from terminal 201-k. Switch 202 forwards those commands to data-processing system 203 in well-known fashion. It will be clear to those skilled in the art how to make and use switch 202.

As will be appreciated by those skilled in the art, in some embodiments two or more telecommunications terminals might be connected via a plurality of switches during a call. It will be clear to those skilled in the art how to make and use telecommunications system 200 with additional switches present and where different switches host different telecommunications terminals.

In accordance with the illustrative embodiment of the present invention, data-processing system 203 plays user-controllable, audio segments such as musical compositions (e.g., songs, etc.) for callers who are on hold during a call. In other words, data-processing system 203 provides a “music-on-hold” capability, as is known in the art, which is controllable by the user.

Optionally, data-processing system 203 also records voice messages for callers who are sent to voice mail and want to leave a voice mail message (or “voice message”) for the person they called. As will be appreciated by those skilled in the art, in some alternative embodiments, data-processing system 203 might not provide a voice mail capability.

Data-processing system 203 receives from switch 202 commands that originate from one or more terminals 201-k. The commands are used to control the playback of the audio segments or the recording of the voice messages, or both.

Data-processing system 203 transmits one or more audio segments to terminal 201-k via switch 202 when terminal 201-k (or its user) is on hold. Data-processing system 203 also transmits one or more voice messages to terminal 201-k via switch 202 when terminal 201-k (or its user) is retrieving voice mail.

Data-processing system 203 is accommodated in a Personal Computer (PC) Card form factor, as is known in the art, in accordance with the illustrative embodiment of the present invention. The PC Card that accommodates data-processing system 203 plugs into switch 202. It will be clear, however, to those skilled in the art how to accommodate data-processing system 203 in other form factors.

It will be clear those skilled in the art, after reading this specification, how to make and use data-processing system 203.

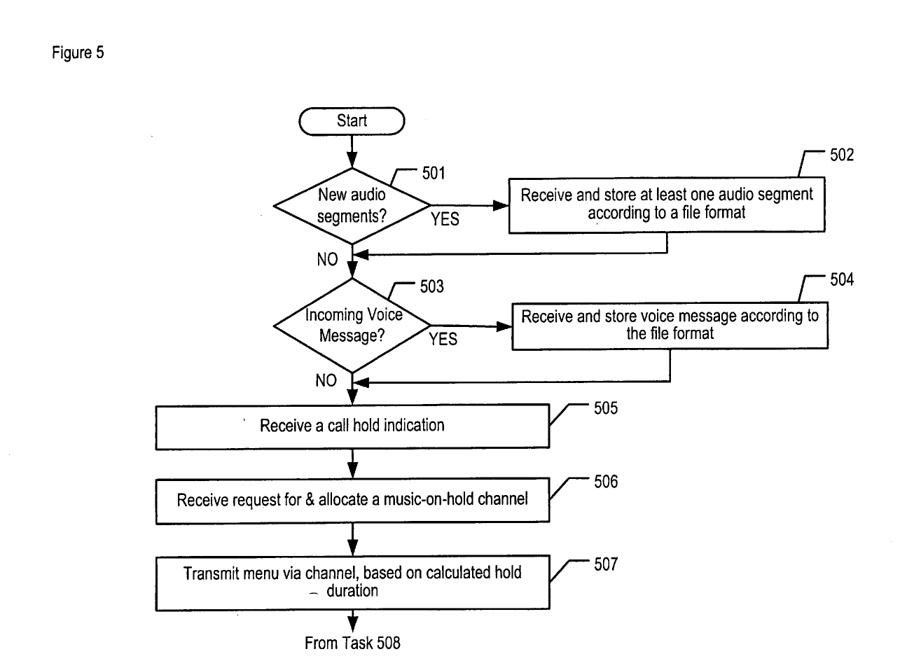

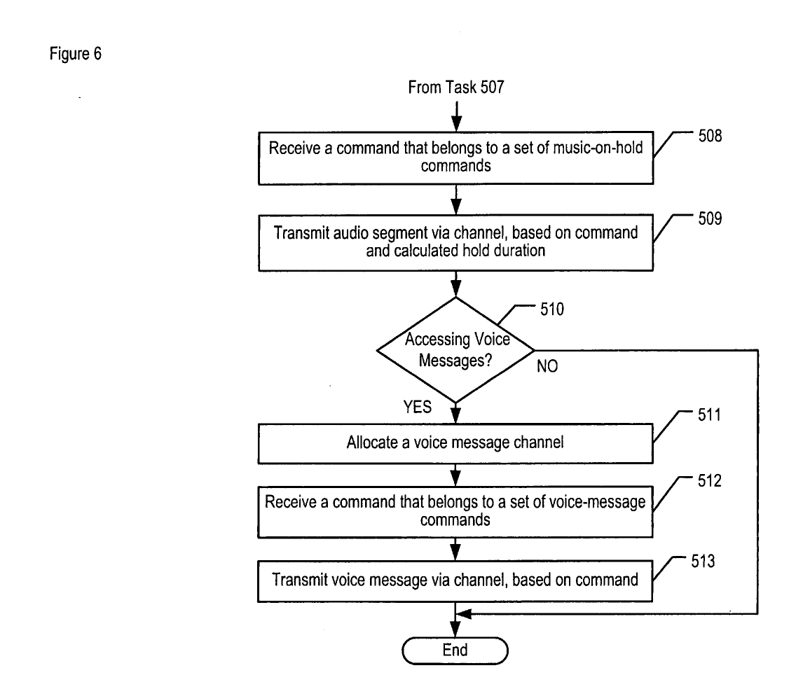

Communications channel 204-p, wherein p can be an integer value between 1 and P, inclusive, is described below and with respect to FIGS. 5 and 6. It will be clear to those skilled in the art how to make and use communications channel 204-p.

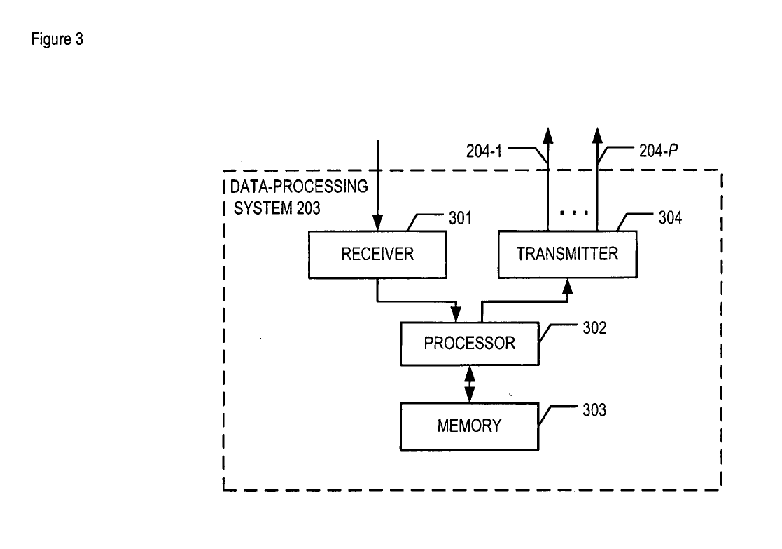

FIG. 3 depicts a block diagram of the salient components of data-processing system 203, in accordance with the illustrative embodiment of the present invention. Data-processing system 203 comprises receiver 301, processor 302, memory 303, and transmitter 304, interconnected as shown.

Receiver 301 receives from switch 202 signals that convey commands that originate from terminal 201-k and forwards the information encoded in the signals to processor 302, in well-known fashion. It will be clear to those skilled in the art, after reading this specification, how to make and use receiver 301.

Processor 302 is a general-purpose processor that is capable of receiving information from receiver 301, of executing instructions stored in memory 303, of reading data from and writing data into memory 303, of executing the tasks described below and with respect to FIGS. 5 and 6, and of transmitting information to transmitter 304. In some alternative embodiments of the present invention, processor 302 might be a special-purpose processor. In either case, it will be clear to those skilled in the art, after reading this specification, how to make and use processor 302.

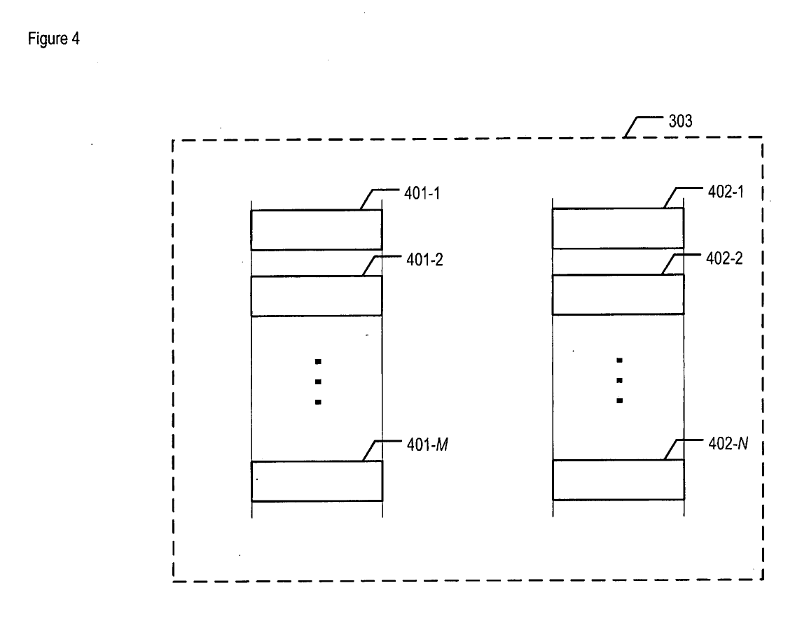

Memory 303 stores data and executable instructions, as is well-known in the art, and might be any combination of random-access memory (RAM), flash memory, disk drive memory, etc. The manner in which information is stored and organized in memory 303 is described below and with respect to FIG. 4.

At least a portion of memory 303 is removable, in accordance with the illustrative embodiment of the present invention. The removable portion of memory stores one or more audio segments, described below and with respect to FIG. 4. In some alternative embodiments, none of memory 303 might be removable and the audio segments are stored in non-removable memory.

It will be clear to those skilled in the art, after reading this specification, how to make and use memory 303.

Transmitter 304 receives information from processor 302 and transmits signals that encode this information to terminal 201-k, in well-known fashion, via switch 202. It will be clear to those skilled in the art, after reading this specification, how to make and use transmitter 304.

FIG. 4 depicts how information is stored and organized in memory 303, in accordance with the illustrative embodiment of the present invention. Memory 303 stores audio segment files 401-1 through 401-M, wherein M is a positive integer, in one or more portions of memory that constitute an “audio segment box.” In those embodiments of the present invention that provide a voice messaging capability, memory 303 also stores voice message files 402-1 through 402-N, wherein N is a positive integer, in one or more portions of memory that constitute a “voice mail box.”

Audio segment file 401-m stores a portion of audio information (i.e., an audio segment). In some embodiments, the audio information in audio segment file 401-m is a musical composition, such as a song, where each audio segment file 401-m is used to store a different audio segment that comprises a different musical composition.

Each audio segment file 401-m is addressable, in that a command received by data-processing system 203 can access each audio segment independently. For example, one command might indicate direct access to a particular audio segment (e.g., go to track 3, etc.) or passing over a particular audio segment (e.g., skip ahead one track, skip backward one track, etc.); as a result, processor 302 retrieves from memory 303 the corresponding audio segment file (e.g., audio segment file 401-3, etc.).

Audio segment files 401-1 through 401-M are all stored in the same file format, in accordance with the illustrative embodiment. File formats include formats specified by the Motion Picture Experts Group (e.g., “MP3 ”, etc.) and WAV format, as are well-known in the art.

It will be clear to those skilled in the art how to write audio segment file 401-m into and read audio segment file 401-m from memory 303.

Voice message file 402-n stores a voice message, such as a message that is left as voice mail for a telecommunications terminal user who does not answer a call.

Each voice message file 402-n is addressable so that a command received by data-processing system 203 can access each voice message independently. For example, one command can indicate going to a particular voice message (e.g., go to the second message, etc.) or passing over a particular voice message (e.g., skip ahead one message, skip backward one message, etc.); as a result, processor 302 retrieves from memory 303 the corresponding voice message file (e.g., voice message file 402-2, etc.).

Voice message files 402-1 through 402-N are all stored in the same file format, in accordance with the illustrative embodiment. File formats include formats specified by the Motion Picture Experts Group (e.g., “MP3”, etc.) and WAV format, as are well-known in the art. Furthermore, voice message files 402-1 through 402-N, when present, are stored in the same file format as are audio segment files 401-1 through 401-M, in accordance with the illustrative embodiment of the present invention. In some alternative embodiments, voice message files 402-1 through 402-N might be stored in a file format that is different from that of audio segment files 401-1 through 401-M.

It will be clear to those skilled in the art how to write into and read from memory 303 voice message file 402-n.

It will be clear to those skilled in the art how to write voice message file 402-n into and to read voice message file 402-n from memory 303.

FIGS. 5 and 6 depict flowcharts of the salient tasks performed by data-processing system 203, in accordance with the illustrative embodiment of the present invention. The description that follows uses terminals 201-1 through 201-4 as examples. Terminal 201-1's user calls terminal 201-2's user, but is sent to voice mail. Subsequently, terminal 201-2's user retrieves the voice mail left by terminal 201-i's user (or retrieves voice mail left by others). In addition, terminal 201-3's user is on a call with terminal 203-4's user, but is put on hold.

It will be clear to those skilled in the art which tasks depicted in FIGS. 5 and 6 can be performed simultaneously or in a different order than that depicted. Furthermore, it will be clear to those skilled in the art, after reading this specification, as to which tasks can be omitted in the embodiments where the voice messaging capability is not present.

At task 501 shown in FIG. 5, data-processing system 203 identifies whether new audio segments are to be downloaded. Data-processing system 203 notifies an administrator of data-processing system 203, based on an administrator-specifiable trigger such as one that is time-based (e.g., a monthly reminder, etc.), to consider downloading new music. It will be clear to those skilled in the art how to apply triggers other than time-based triggers. If new audio segments are not to be downloaded, execution proceeds to task 503.

At task 502, data-processing system 203 receives, in well-known fashion, one or more audio segments according to a file format. Data-processing system 203 then stores the audio segments into memory 303. The removable portion of memory 303 plugs into a personal computer with card reader capability and accepts downloaded audio segment files. This is done in a manner similar to how a music file player (e.g., “MP3 player,” etc.) receives downloaded files. In some alternative embodiments, the PC card itself that comprises data-processing system 203 connects physically to a computer to accept downloaded audio segment files.

Once connected back into switch 202, data-processing system 203 is then enabled so that it can: (i) play audio segments for users that are on hold, and (ii) record voice messages for callers that are directed to voice mail.

At task 503, data-processing system 203 determines in well-known fashion if it is to record a voice message. If not, execution proceeds to task 505.

At task 504, data-processing system 203 receives, in well-known fashion, a signal that conveys a voice message. For example, this occurs when a caller who is associated with terminal 201-1 attempts to call a person who is associated with terminal 201-2, but does not answer; terminal 201-1 is then connected by switch 202 to the voice mail function in well-known fashion. Processor 302 receives an audio signal that conveys the voice message from the user of terminal 201-1 and converts the message into the appropriate file format. Data-processing system 203 then stores the voice message file in memory 303.

At task 505, data-processing system 203 receives a call-hold indication from switch 202 in well-known fashion. For example, the user of terminal 201-4 places the user of terminal 201-3 on hold by signaling switch 202. As a result, switch 202 connects the audio path from terminal 201-3 to a channel to switch 202's music-on-hold interface with data-processing system 203.

At task 506, data-processing system 203 receives a request for and allocates an unused communications channel 204-p for terminal 201-3 in well-known fashion. The received call-hold indication can constitute the request for a communications channel. In accordance with the illustrative embodiment, communications channel 204-p is a virtual channel, in that it is established by allocating a message slot in a data stream that is transmitted into a physical channel. The physical channel, as a result, is shared by more than one terminal on hold. In some alternative embodiments, communications channel 204-p might be one of many physical channels that is assigned uniquely to a terminal on hold (e.g., terminal 201-3, etc.).

Communications channel 204-p is linked to the channel that is associated with terminal 201-3 on the switch side, in well-known format.

At task 507, data-processing system 203 retrieves from memory 303 a file comprising a playback menu announcement. Data-processing system 203 transmits the menu to terminal 201-3 via switch 202. The transmitted menu refers to at least one command that the user of terminal 201-3 can use to control the music-on-hold capability. For example, the playback menu announcement might include, “At any time when the music is playing, press ‘4’ to skip backward to the previous song or press ‘6’ to skip forward to the next song.”

At task 508 shown in FIG. 6, data-processing system 203 receives a command that belongs to a non-empty set of commands. The command arrives at receiver 301 from terminal 201-3 as a dual tone multi-frequency signal, as is known in the art and in accordance with the illustrative embodiment. In some alternative embodiments, the command might be encoded in a message frame or packet. The user of terminal 201-3 enters the command using terminal 201-3's keypad. The command is one of the commands referred to by the transmitted menu, described with respect to task 507.

At task 509, data-processing system 203 retrieves audio segment file 401-m from memory 303, based on the received command. For example, if the file currently in use is audio segment file 401-1 and the received command indicates to skip ahead to the next audio segment, then data-processing system 203 retrieves audio segment file 401-2. Processor 302 converts the file into an audible waveform of the audio segment in well-known fashion. Transmitter 304 transmits the audio segment via allocated communications channel 204-p that corresponds to terminal 201-3.

In accordance with the illustrative embodiment, the transmission of the menu and the command-driven audio segment is based on the calculated amount of time on hold. Calculating (e.g., estimating, etc.) the amount time that a user will be on hold is well-known in the art. For example, if the estimated wait time is less than an administrator-specified value (e.g., one minute, etc.), data-processing system 203 does not allow the user to control the playback and does not advertise the capability (i.e., does not transmit the menu). In some alternative embodiments, the menu and command-based audio segment might be transmitted regardless of the calculated amount of time on hold.

Tasks 505 through 509 may be executed one or more times for a given terminal 201-k for a given call-hold event. Furthermore, tasks 505 through 509 may be executed for multiple terminals 201-k, depending on how many terminals 201-k are put on hold. It will be clear to those skilled in the art, after reading this specification, how to manage the music-on-hold capability, controllable on a per-terminal basis, for multiple terminals 201-k that are on hold simultaneously.

At task 510, data-processing system 203 determines whether it is receiving a request to access one or more voice mail messages. If not, execution ends.

At task 511, data-processing system 203 allocates an unused communications channel 204-p (e.g., to terminal 201-2, etc.), in well-known fashion. In accordance with the illustrative embodiment, communications channel 204-p is a virtual channel, in that it is established by allocating a message slot in a data stream that is transmitted into a physical channel. The physical channel, as a result, is shared by more than one terminal that is accessing voice mail. In some alternative embodiments, communications channel 204-p might be one of many physical channels that is assigned uniquely to a terminal that is accessing voice mail, such as terminal 201-2.

Communications channel 204-p is linked to the channel that is associated with terminal 201-2 on the switch side.

At task 512, data-processing system 203 receives a command that belongs to a non-empty set of commands. The command arrives at receiver 301 from terminal 201-2 as a dual tone multi-frequency signal, as is known in the art and in accordance with the illustrative embodiment. In some alternative embodiments, the command is encoded in a message frame or packet. The user of terminal 201-2 enters the command using terminal 201-2's keypad.

In some embodiments, at least one of the commands that controls voice mail playback is invoked in the same manner as at least one of the commands that controls audio segment playback for music-on-hold. For example, the user playing back voice messages might press “6” on the keypad to skip ahead one voice message, and the user playing audio segments while on hold might also press “6” on the keypad to skip ahead one audio segment. Consequently, the command set can be harmonized across the two capabilities—that is, music-on-hold and voice mail retrieval—in data-processing system 203. This is particularly helpful for users of both (i) the music-on-hold capability and (ii) the voice mail retrieval capability.

At task 513, data-processing system 203 retrieves voice message file 402-n from memory 303, based on the received command. For example, if the file currently in use is voice message file 402-1 and the received command indicates to skip ahead to the next voice message, then data-processing system 203 retrieves voice message file 402-2. Processor 302 converts the file into an audible waveform of the voice message in well-known fashion. Transmitter 304 transmits the voice message via allocated communications channel 204-p that corresponds to terminal 201-2. After task 513, execution ends.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising:
receiving at a data-processing system a first signal that conveys a command from a telecommunications terminal; and
transmitting from said data-processing system to said telecommunications terminal an audio segment based on said command;
wherein said telecommunications terminal is on hold during a call.

2. The method of claim 1 further comprising:
receiving at said data-processing system a second signal that indicates that said telecommunications terminal is on hold; and
transmitting from said data-processing system to said telecommunications terminal a menu that refers to said command.

3. The method of claim 2 further comprising allocating a communications channel for the transmission of said menu and said audio segment to said telecommunications terminal.

4. The method of claim 2 wherein the transmission of said audio segment and the transmission of said menu are based on a calculated duration of said hold.

5. The method of claim 1 wherein said audio segment is one of a plurality of audio segments, and wherein each of said audio segments comprises a different musical composition.

6. The method of claim 1 wherein said data-processing system receives said command in the form of one or more dual tone multi-frequency signals.

7. The method of claim 1 further comprising storing at said data-processing system (i) said audio segment and (ii) a voice message, wherein said audio segment and said voice message are stored in the same file format.

8. A method comprising:
receiving at a data-processing system a first signal that conveys a request for a first communications channel for a first telecommunications terminal that is on hold during a call;
receiving at said data-processing system a second signal that conveys a first command from said first telecommunications terminal via said first communications channel; and
transmitting to said first telecommunications terminal via said first communications channel a first audio segment that is based on said first command.

9. The method of claim 8 wherein said call also involves a second telecommunications terminal, and wherein said second telecommunications terminal accesses at least one voice message from said data-processing system while said first telecommunications terminal is on hold.

10. The method of claim 8 further comprising:
receiving at said data-processing system a third signal that conveys a request for a second communications channel for a third telecommunications terminal that is on hold during a call;
receiving at said data-processing system a fourth signal that conveys a second command from said third telecommunications terminal via said second communications channel; and
transmitting a second audio segment to said third telecommunications terminal via said second communications channel, based on said second command;
wherein said first audio segment and said second audio segment are different.

11. The method of claim 8 wherein the transmission of said first audio segment is based on an estimated duration of said hold.

12. The method of claim 8 wherein said first command specifies skipping to a different audio segment than said first audio segment.

13. The method of claim 8 wherein said audio segment is one of a plurality of audio segments, and wherein each of said audio segments comprises a different musical composition.

14. The method of claim 8 wherein said data-processing system receives said first command in the form of one or more dual tone multi-frequency signals.

15. The method of claim 8 further comprising storing at said data-processing system (i) said audio segment and (ii) a voice message, wherein said audio segment and said voice message are stored in the same file format.

16. A method comprising:
receiving at a data processing system:
(i) a plurality of audio segments, wherein each audio segment of said plurality comprises a musical composition, and
(ii) a voice message from a first telecommunications terminal, wherein said voice message is for the user of a second telecommunications terminal; and
transmitting from said data processing system:
(i) an audio segment of said plurality to a third telecommunications terminal, and
(ii) said voice message to said second telecommunications terminal.

17. The method of claim 16 further comprising storing said plurality of audio segments and said voice signal in the same file format.

18. The method of claim 16 further comprising receiving (i) a first signal that conveys a first command for controlling playback of said audio segment and (ii) a second signal that conveys a second command to control playback of said voice mail, wherein said first command and said second command are invoked in the same manner.

19. The method of claim 18 wherein said first command specifies skipping to a different audio segment than said audio segment.

20. The method of claim 18 wherein said data-processing system receives said first command in the form of one or more dual tone multi-frequency signals.
